(19) United States
(12) Patent Application Publication
(10) Pub. No.: US 2022/0266467 A1
(43) Pub. Date: Aug. 25, 2022

(54) Method for the attachment of a plurality of knife holders onto a slitting machine, a mounting kit for the attachment of a plurality of knife holders onto a slitting machine, a knife holder, a positioning bar, and a slitting machine

(71) Applicant: Dienes Werke für Maschinenteile GmbH & Co. KG, Overrath (DE)

(72) Inventor: Rudolf Supe-Dienes, Overrath (DE)

(21) Appl. No.: 17/676,090

(22) Filed: Feb. 18, 2022

(30) Foreign Application Priority Data
Feb. 23, 2021 (DE) 102021104322.0

(51) Int. Cl. B26D 7/26

(52) U.S. Cl. CPC B26D 7/2621; B26D 7/2635

(57) ABSTRACT

The present invention relates to a method, a mounting kit, a positioning bar, a knife holder, and a slitting machine, by means of which a plurality of knife holders can be attached, at a determined spacing from one another, onto a traverse of the slitting machine. The method comprises in particular the following steps:
Providing at least two knife holders,
Providing at least one positioning bar, wherein the positioning bar has at least two form-fit configurations,
Making a mounting unit, by the attaching the knife holders onto the positioning bar at the positions determined by the form-fit configurations, wherein adjacent form-fit configurations on the positioning bar determine the spacing between adjacent knife holders,
Positioning the mounting unit on the traverse,
Fixing the knife holders onto the traverse at the spacing from one another determined by the positioning bar.

The present invention relates to the attachment of a plurality of knife holders, at a determined spacing from one another, onto a traverse of a slitting machine. Accordingly, a method for the attachment of a plurality of knife holders, at a determined spacing from one another, onto a traverse of a slitting machine, a mounting kit for at least one mounting unit for the attachment of a plurality of knife holders, at a determined spacing from one another, onto a traverse of a slitting machine, a knife holder, a positioning bar for a plurality of knife holders, and a slitting machine, are proposed.

From DE 10 2014 105 375 A1, for example, a slitting machine with a traverse, to which a plurality of knife holders can be attached, is known. In order to determine the spacing between adjacent knife holders, it is proposed in DE 10 2014 105 375 A1 to attach an interchangeable strip to the traverse, which strip has a plurality of detent recesses, wherein detent pins attached to the knife holder engage in the detent recesses. The spacing between adjacent knife holders is thus determined by the spacing between the detent recesses on the interchangeable strip. The knife holders are individually positioned on the traverse, and are fixed to the traverse with a clamping device that is arranged on each of the knife holders.

In order to alter the spacing between adjacent knife holders, the clamping device may need to be first loosened, each knife holder may need to be removed from the traverse, the strip with the detent recesses may need to be replaced, and then each knife holder may need to be individually reattached to the traverse in its position determined by the detent recesses, wherein the clamping device is then tightened. This solution is linked with the disadvantage that the traverse, which is fitted as a fixed component of a slitting machine, must be fitted or modified for the reception of the strip.

It is therefore the object of the present invention to eliminate the disadvantages described with respect to the prior art and, in particular, to provide a method, a mounting kit, a positioning bar, a knife holder, as well as a slitting machine, with which adjacent knife holders can be attached to a slitting machine at a determined spacing in an alternative manner, and preferably in a retrofittable manner.

Possible solutions of this object are given in the independent claims, wherein advantageous developments are specified in the subordinate claims and in the description. Individual features of the advantageous developments can be combined with each other in a technically logical manner. Features described with respect to the method are applicable to the mounting kit, the positioning bar, the knife holder, and the slitting machine respectively, and vice versa.

In particular, a method is proposed for the attachment of a plurality of knife holders, at a determined spacing from one another, onto a traverse of a slitting machine, wherein the method in particular comprises at least some of the following steps:
Providing at least two, preferably at least three, or even at least four, knife holders,
Providing at least one positioning bar, wherein the positioning bar, or each positioning bar, has at least two form-fit configurations,
Making a mounting unit, by the attachment of the knife holders onto the positioning bar at the positions determined by the form-fit configurations, wherein adjacent form-fit configurations on the positioning bar determine the spacing between adjacent knife holders,
Positioning the mounting unit on the traverse, and
Fixing at least one knife holder onto the traverse at the spacing between the knife holders as determined by the positioning bar, wherein in particular a clamping device provided on at least one knife holder is actuated for this purpose.

Also proposed is a mounting kit for at least one mounting unit for the attachment of a plurality of knife holders, at a determined spacing from one another, onto a traverse of a slitting machine, wherein the mounting kit comprises in particular at least two knife holders and at least one positioning bar, wherein the positioning bar has at least two form-fit configurations and the knife holders can be attached onto the positioning bar at the positions determined by the form-fit configurations so as to produce a mounting unit, wherein adjacent form-fit configurations on the positioning bar determine the spacing between adjacent knife holders.

In addition, an invention is seen in a corresponding positioning bar for the attachment of at least two knife holders onto a traverse of a slitting machine, wherein the positioning bar has at least two form-fit configurations, by means of which a knife holder can be attached in each case at a position determined by the form-fit configurations.

A further invention is seen in a knife holder, which comprises at least a housing, a knife head for holding a circular knife, and a clamping device for fixing the knife holder onto a slitting machine, wherein the knife holder has at least one form-fit formation for purposes of a precise connection with a form-fit configuration of a positioning bar. The form-fit formation can, for example, be arranged in or on the housing of the knife holder. However, the form-fit formation can also be provided in or on another component of the knife holder.

In addition, an invention is seen in a slitting machine with a traverse and a plurality of knife holders, wherein the knife holders can be attached to the traverse at a spacing from one another, and wherein the slitting machine has at least one positioning bar, wherein the positioning bar has at least two form-fit configurations, by means of which a position of a knife holder is determined in each case, wherein adjacent form-fit configurations on the positioning bar determine the spacing between adjacent knife holders, and wherein the positioning bar can be positioned on the traverse together with the knife holders. At least one, or the one, positioning bar can remain in its state in which it is attached to a plurality of knife holders, or it can be removed from the knife holders after the knife holders have been fixed to the traverse.

In particular, it is proposed that with the attachment of at least two knife holders onto the at least one positioning bar, a mounting unit, to be understood to be a cassette or a pack, is pre-assembled, wherein the knife holders of a mounting unit pre-assembled in this way are positioned together/at the same time on the traverse of the slitting machine. Here the spacing of the knife holders from one another is exactly determined by the spacing between the form-fit configurations on the at least one positioning bar. By the provision of a form-fit configuration, the position of the knife holders and thus also their spacing from one another is precisely determined, even before the knife holders are attached to the traverse. It is therefore no longer necessary to adjust the individual positions of the knife holders on the traverse. The spacing between the knife holders can thereby also be independent of the configuration of the traverse. Here the positioning bar and/or the knife holders can be designed and, in particular, arranged relative to each other in such a way that the pre-assembled mounting unit can be attached to traverses of known art.

A form-fit configuration is in particular designed when a position of the knife holder is determined by a shape of the positioning bar, insofar as the knife holder, after attachment onto the positioning bar, cannot be moved along the positioning bar by virtue of the shape. The form-fit configuration can, for example, be designed as a recess, wherein a section of the knife holder, when attached to the positioning bar, is arranged in the recess, such that the knife holder cannot be moved along the positioning bar. The recess can, for example, be designed as a hole in the positioning bar, or can be arranged on an edge of the positioning bar, and can thus be open to one side. Such a positioning bar can also be used with knife holders of known art, without the need to adapt the knife holders.

However, a form-fit configuration can preferably be designed as at least one projection, wherein in particular the knife holders in each case have at least one corresponding recess for purposes of receiving the at least one projection. For example, the projection on the positioning bar can have a rectangular or round cross-section, wherein in this case the knife holders have a recess with a round or angular cross-section, into which the at least one projection can be inserted with a precise fit. Such a recess falls under the generic term of a form-fit formation, which can also be designed as a thread or a plain hole. A form-fit formation on the knife holder can alternatively be implemented as a projection, in which case the form-fit configuration on the positioning bar is designed, for example, as a recess that is complementary to the projection. Each individual knife holder thus has a form-fit formation that is designed, for example, as a recess or a projection. The knife holder can have a recess adjacent to the form-fit formation for purposes of receiving the positioning bar, so that the positioning bar does not protrude beyond the outer contour of the knife holder in the region overlapping with the knife holder. The recess is thus designed, in particular, in a housing of the knife holder.

If only just one positioning bar is provided for a mounting unit, at least one fixing element should be provided, which fixes the knife holders onto the positioning bar.

The fixing element can be formed, for example, by the form-fit configuration of the positioning bar, or by the form-fit formation of the knife holder itself. Thus an elastically designed projection with a type of hook can be provided, for example. The hook is then deflected when the projection is introduced into the recess in the knife holder (or in the positioning bar) and, in the attached state, engages behind an undercut formed in the recess. The projection forming the form-fit configuration for purposes of determining the position of the knife holder on the positioning bar is thus, at the same time, an elastically-deflectable fixing element. Alternatively, an elastically-deflectable fixing element can be arranged/formed on the knife holder, which in particular can interact with the form-fit configuration for fixing purposes.

In this context, it is preferable if a form-fit configuration or a form-fit formation has at least two elastically-deflectable projections, which can be introduced together into a recess, so as to fix the positioning bar to the knife holder.

However, provision can also made for a separate fixing element to be provided in the design of the form-fit configuration, with which the knife holder is fixed after its precise positioning onto the positioning bar. Such a separate fixing element can also be provided in addition to the form-fit configuration. Such a separate fixing element can, for example, be designed as a screw that is inserted through an opening in the positioning bar, and screwed into a thread on the knife holder.

In principle, it is sufficient if just one positioning bar is provided for each mounting unit. However, for a better alignment of the knife holders relative to each other, and for an easier positioning on the traverse, it is proposed that a positioning bar group is provided for each mounting unit, which group comprises at least two, preferably precisely two, positioning bars, wherein the positioning bars in each case have at least two form-fit configurations for purposes of determining the position of the knife holders, wherein the spacing between the form-fit configurations of the at least two profile bars of a profile bar group determines the same spacing between adjacent knife holders.

Thus, for example, a first positioning bar of a positioning bar group, when attached to the slitting machine, can be arranged on a side of the knife holder facing towards the traverse. A form-fit formation (recess) of the knife holder is therefore formed on the side of the clamping device, and preferably in a region that is covered by the traverse when the latter is in the attached state.

Alternatively, a first positioning bar, or a further positioning bar of a positioning bar group, when attached to the traverse, can be arranged on a side of the knife holder facing away from the traverse. A form-fit formation (recess) of the knife holder is thus designed on the side facing away from the clamping device.

In principle, it would be conceivable that all knife holders of a slitting machine are pre-assembled into a mounting unit by means of at least one positioning bar. However, it can also be envisaged that at least two knife holders, in each case spaced apart from one another by means of at least one positioning bar, are arranged one behind the other along the traverse. In this case, the mounting kit comprises at least two profile bar groups, in each case with at least one positioning bar. For the precise spacing of knife holders of different mounting units, the positioning bars, when attached to the traverse, can abut against each other with their mutually facing end faces. Accordingly, at least two mounting units are therefore arranged on the one traverse of a slitting machine.

In order to alter the spacing of adjacent knife holders, the knife holders are first removed from the traverse, wherein this can be done as a mounting unit if necessary, if the clamping devices of all knife holders are released. The removed knife holders, or another group of knife holders, are attached to at least one further positioning bar, wherein the form-fit configurations of this further positioning bar have a different spacing between each other than the form-fit configurations of the profile bar previously used.

If a large number of knife holders are present, a mounting unit can thus be pre-assembled, while other knife holders are still in operation in the slitting machine. It is thus possible to change the knife holders quickly, and set a different spacing. Accordingly, the mounting kit has at least two positioning bar groups, in each case with at least one positioning bar, wherein the positioning bar(s) of one positioning bar group differ from the at least one positioning bar of another positioning bar group in terms of the spacing between the form-fit configurations.

In particular, the knife holders are designed to hold a circular knife (such as a crush knife, scissors knife, or razor knife) for a crush cut or a hot cut. In particular, the knife holders in each case have a knife head mounted such that it can rotate. Each knife holder can also have a clamping device for purposes of fixing the knife holder onto the traverse of the slitting machine. The knife holder can also have a drive, with which the knife head can be rotationally driven, or lowered.

The traverse of the slitting machine can, for example, have a dovetail configuration in cross-section. The clamping device preferably has a shape that is complementary to that of the traverse, so that the knife holder can be moved along the traverse, and has a fixing element that is to be actuated for fixing purposes.

Such a slitting machine can be used, for example, to cut, in particular, double-sided adhesive tape, carrying handles, or battery foil.

The invention and the technical background are explained in what follows, using the figures by way of example. Here:

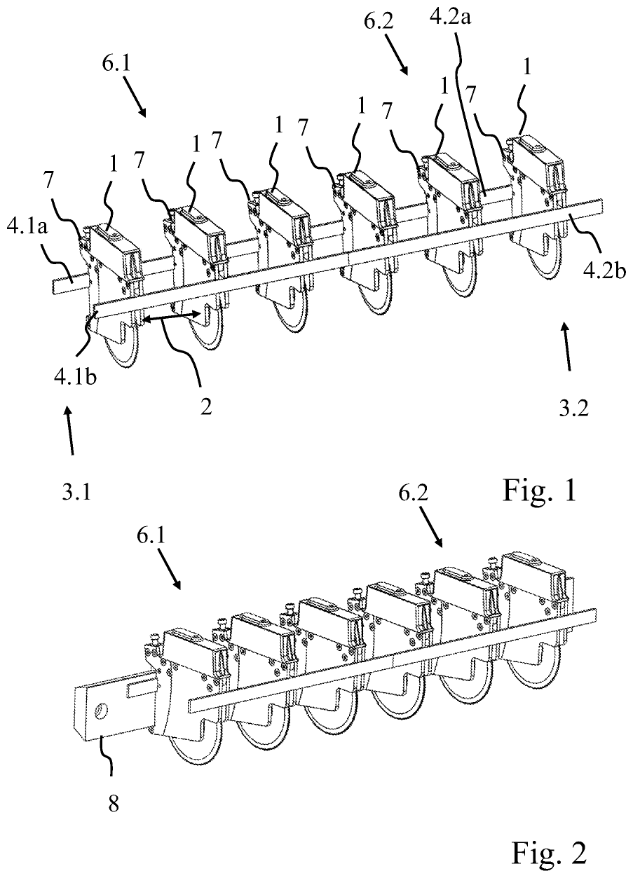

FIG. 1: shows schematically a view in perspective of two mounting units arranged next to each other,

FIG. 2: shows schematically a view in perspective of the mounting units attached to a traverse,

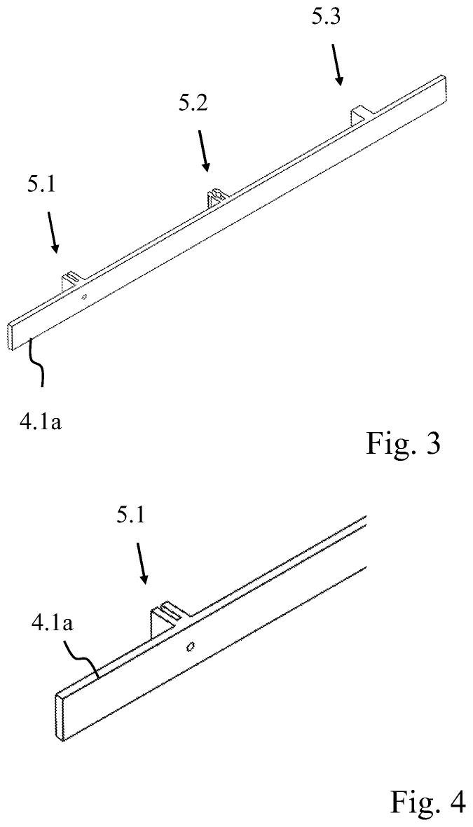

FIG. 3: shows schematically a positioning bar of the mounting units,

FIG. 4: shows schematically a detailed view of a first form-fit configuration of the positioning bar,

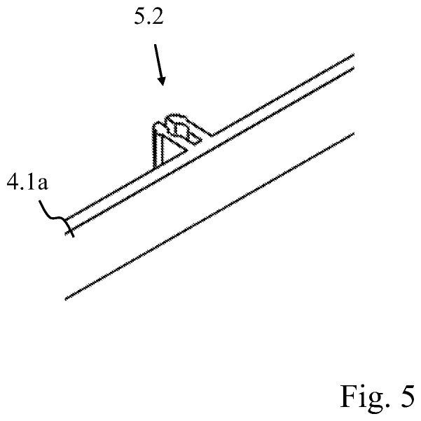

FIG. 5: shows schematically a detailed view of a second form-fit configuration of the positioning bar, and

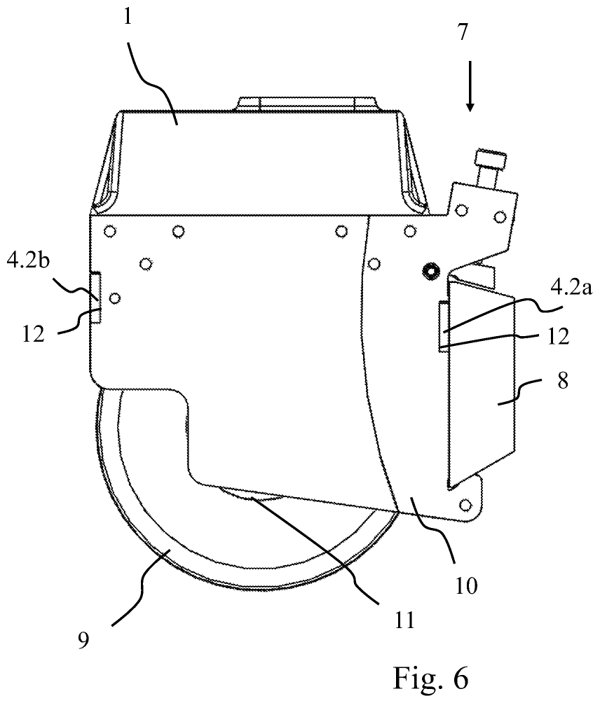

FIG. 6: shows schematically a side view of a mounting unit attached to a traverse.

FIG. 1 shows a view in perspective of a first pre-assembled mounting unit 6.1 and a second pre-assembled mounting unit 6.2.

The mounting units 6.1 and 6.2 in each case comprise three knife holders 1, which are arranged at a spacing 2 from one another. The first mounting unit 6.1 comprises a first positioning bar group 3.1, with the positioning bar 4.1a and the positioning bar 4.1b. The second mounting unit 6.2 comprises a second positioning bar group 3.2, with the positioning bars 4.2a and 4.2b.

In the state shown in FIG. 1 the mounting units 6.1 and 6.2 can be positioned on a traverse 8 of a slitting machine, and can be fixed to the traverse 8 by the tightening of clamping devices 7. The advantage here is that the spacing 2 between the knife holders 1 is determined by form-fit configurations on the positioning bars, which are explained in more detail below. Thus, a plurality of knife holders 1 can be fixed together to the traverse 8 with a spacing 2 that has already been previously determined. FIG. 2 shows the two mounting units 6.1 and 6.2 in a state in which they are attached to the traverse 8 of a slitting machine.

FIG. 3 shows the first positioning bar 4.1a, which has three form-fit configurations 5.1, 5.2 and 5.3. As a rule, all the form-fit configurations of a positioning bar have the same geometric configuration. In order to illustrate the different possibilities for the design of form-fit configurations, the three form-fit configurations 5.1 to 5.3 are configured differently in the example of embodiment of FIG. 3.

Thus the first form-fit configuration 5.1 shown in detail in FIG. 4 comprises two projections which arise transversely to the longitudinal extent of the positioning bar 4.1a. The knife holder, which is not shown in detail, has a recess designed as a form-fit configuration that corresponds with the outer peripheral configuration of the two projections, such that the two projections are received into the recess in a precise fit. To fix the knife holder 1 to the positioning bar 4.1a, a screw can be inserted through the hole shown in the first form-fit configuration 5.1 and screwed into a thread in the knife holder.

The second form-fit configuration 5.2 shown in detail in FIG. 5 comprises two elastically-deflectable projections, which can be inserted into a corresponding recess acting as a form-fit formation on a knife holder. When the projections are inserted into the recess, the projections are deflected towards each other and upon reaching the end position can snap back, such that a kind of snap-in or click-in connection is established between the knife holder and the positioning bar 4.1a.

The third form-fit configuration 5.3 is a simple rectangular projection that can be inserted into a corresponding recess in the knife holder 1.

The precise spacing 2 between two adjacent knife holders 1 attached to the positioning bar is thus determined by the spacing between adjacent form-fit configurations 5.1, 5.2 and 5.3 on the positioning bar.

In this manner, the knife holders can already be arranged at a desired spacing 2 from one another before they are attached to the traverse 8 of the slitting machine, wherein after they have been attached to the traverse 8, they only need to be fixed in place by an actuation of the clamping device 7.

FIG. 6 shows a side view onto a knife holder 1 of a mounting unit 6.2, in a state in which it is attached to the traverse 8. FIG. 6 shows in the first instance the configuration of the clamping device 7, which has a formation corresponding to that of the traverse 8, and by means of a fixing element can fix the knife holder 1 onto the traverse 8.

In addition, it can be seen that a housing 10 of the knife holder 1 has one recess 12 on the side facing towards the traverse 8, and another on the side facing away from the traverse 8, in which the positioning bars 4.2a and 4.2b are respectively arranged. The form-fit configurations of the positioning bars 4.2a, 4.2b, which are not visible in FIG. 6, engage in a form-fit formation in the form of a recess, which is designed in the knife holder 1 adjacent to the recess 12. Since the recesses 12 enable the positioning bars 4.2a, 4.2b not to protrude beyond the outer contour of the knife holder 1, a positioning bar 4.2a can also be arranged on the side facing towards the traverse 8, without any need to modify the traverse 8.

### LIST OF REFERENCE SYMBOLS

1 Knife holder
2 Spacing
3.1 First positioning bar group
3.2 Second positioning bar group
4.1a Positioning bar
4.1b Positioning bar
4.2a Positioning bar
4.2b Positioning bar
5.1 First form-fit configuration
5.2 Second form-fit configuration
5.3 Third form-fit configuration
6.1 First mounting unit
6.2 Second mounting unit
7 Clamping device
8 Traverse
9 Circular knife
10 Housing
11 Knife head
12 Recess

1. Method for the attachment of a plurality of knife holders (1), at a determined spacing (2) from one another, onto a traverse (8) of a slitting machine, comprising at least the following steps:
providing at least two knife holders (1),
providing at least one positioning bar (4.1a, 4.1b, 4.2a, 4.2b), wherein the positioning bar (4.1a, 4.1b, 4.2a, 4.2b) has at least two form-fit configurations (5.1, 5.2, 5.3),
making a mounting unit (6.1, 6.2), by attaching the knife holders (1) onto the positioning bar (4.1a, 4.1b, 4.2a, 4.2b) at the positions determined by the form-fit configurations (5.1, 5.2, 5.3), wherein adjacent form-fit configurations (5.1, 5.2, 5.3) on the positioning bar (4.1a, 4.1b, 4.2a, 4.2b) determine the spacing between adjacent knife holders (1),
positioning the mounting unit (6.1, 6.2) on the traverse (8), and
fixing of at least one knife holder (1) onto the traverse (8).

2. Method according to claim 1, wherein for purposes of altering the spacing (2) of adjacent knife holders (1), the knife holders (1) are removed from the traverse (8), and are attached to at least one further positioning bar, the form-fit configurations (5.1, 5.2, 5.3) of which are at a different spacing from one another than that on the previously used profile bar (4.1a, 4.1b, 4.2a, 4.2b).

3. Mounting kit for at least one mounting unit (6.1, 6.2), for purposes of attaching a plurality of knife holders (1) at a determined spacing (2) from one another onto a traverse (8) of a slitting machine, comprising:
at least two knife holders (1), and
at least one positioning bar (4.1a, 4.1b, 4.2a, 4.2b), wherein the positioning bar (4.1a, 4.1b, 4.2a, 4.2b) has at least two form-fit configurations (5.1, 5.2, 5.3), wherein for purposes of making a mounting unit (6.1, 6.2), the knife holders (1) can be attached to the positioning bar (4.1a, 4.1b, 4.2a, 4.2b) at the positions determined by the form-fit configurations (5.1, 5.2, 5.3), wherein adjacent form-fit configurations (5.1, 5.2, 5.3) on the positioning bar (4.1a, 4.1b, 4.2a, 4.2b) determine the spacing (2) between adjacent knife holders (1).

4. Mounting kit according to claim 3, wherein a positioning bar group (3.1, 3.2) with at least two positioning bars (4.1a, 4.1b, 4.2a, 4.2b) is provided for each mounting unit (6.1, 6.2), wherein the positioning bars (4.1a, 4.1b, 4.2a, 4.2b) in each case have at least two form-fit configurations (5.1, 5.2, 5.3) for purposes of determining the position of the knife holders (1).

5. Mounting kit according to claim 3, wherein at least two positioning bar groups (3.1, 3.2) are provided, in each case with at least one positioning bar (4.1a, 4.1b, 4.2a, 4.2b), wherein the positioning bar(s) (4.1a, 4.1b) of one positioning bar group (3.1) differ from the at least one positioning bar (4.2a, 4.2b) of another positioning bar group (3.2) from one another in terms of the spacing (2) between the form-fit configurations (5.1, 5.2, 5.3).

6. Mounting kit according to claim 3, wherein the form-fit configurations (5.1, 5.2, 5.3) are in each case designed as at least one projection.

7. Mounting kit according to claim 6, wherein the knife holders (1) in each case have at least one recess for purposes of receiving the at least one projection.

8. Mounting kit according to claim 3, wherein the form-fit configurations (5.2) comprise at least one elastically-deflectable fixing element.

9. Mounting kit according to claim 3, wherein a separate fixing element is provided, which fixes a knife holder (1) onto a positioning bar (4.1a, 4.1b, 4.2a, 4.2b).

10. Positioning bar for the attachment of at least two knife holders (1) onto a traverse of a slitting machine, wherein the positioning bar (4.1a, 4.1b, 4.2a, 4.2b) has at least two form-fit configurations (5.1, 5.2, 5.3), by means of which a knife holder (1) can in each case be attached at a position determined by the form-fit configuration (5.1, 5.2, 5.3).

11. Knife holder, in particular for a mounting kit according to claim 3, comprising at least:
a housing (10),
a knife head (11) for purposes of holding a circular knife (9), and
a clamping device (7) for purposes of fixing the knife holder (1) to a slitting machine, characterised in that,
the knife holder (1) has at least one form-fit formation for purposes of connection to a form-fit configuration (5.1, 5.2, 5.3) of a positioning bar (4.1a, 4.1b, 4.2a, 4.2b).

12. Knife holder according to claim 11, wherein the knife holder has, adjacent to the form-fit formation, a recess (12) for purposes of receiving the positioning bar (4.1a, 4.1b, 4.2a, 4.2b).

13. Slitting machine with:
a traverse (8),
a plurality of knife holders (1), which can be attached to the traverse (8) at a spacing (2) from one another,
characterised in that,
the slitting machine has at least one positioning bar (4.1a, 4.1b, 4.2a, 4.2b), wherein the positioning bar (4.1a, 4.1b, 4.2a, 4.2b) has at least two form-fit configurations (5.1, 5.2, 5.3), by means of which a position of a knife holder (1) is determined, wherein adjacent form-fit configurations (5.1, 5.2, 5.3) on the positioning bar (4.1a, 4.1b, 4.2a, 4.2b) determine the spacing (2) between adjacent knife holders (1), wherein the positioning bar (4.1a, 4.1b, 4.2a, 4.2b) can be positioned together with the knife holders (1) on the traverse (8), and can preferably be removed from the traverse (8) as a mounting unit (6.1, 6.2).

14. Slitting machine according to claim 13, wherein a positioning bar (4.1a, 4.2a) is arranged on a side of the knife holders (1) facing towards the traverse (8).

15. Slitting machine according to claim 13, wherein a positioning bar (4.1b, 4.2b) is arranged on a side of the knife holder (1) facing away from the traverse (8).

16. Slitting machine according to claim 13, wherein at least two mounting units (6.1, 6.2) are arranged on the traverse (8).

17. Slitting machine according to claim 16, wherein the positioning bars (4.1a, 4.1b, 4.2a, 4.2b) of adjacent mounting units (6.1, 6.2) abut against one another with their end faces.
